(19) United States
(12) Patent Application Publication
(10) Pub. No.: US 2013/0215604 A1
(43) Pub. Date: Aug. 22, 2013

(54) LIGHT EMITTING RIBBON

(71) Applicants: WU-I CHU, Taipei City (TW); Fang-Hsuan Chu, Taipei City (TW); Yu-Lin Chang, Taipei City (TW); Kuei-Hao Hou, Taipei City (TW)

(72) Inventors: WU-I CHU, Taipei City (TW); Fang-Hsuan Chu, Taipei City (TW); Yu-Lin Chang, Taipei City (TW); Kuei-Hao Hou, Taipei City (TW)

(21) Appl. No.: 13/398,848

(22) Filed: Feb. 17, 2012

(51) Int. Cl. F21L 4/02; F21V 21/00

(52) U.S. Cl. 362/184; 362/217.14

(57) ABSTRACT

A light emitting ribbon comprises a main body and an adapter, and the main body is a flexible transparent strip-shaped ribbon having a plurality of LED chips, and the adapter is coupled to the main body and electrically coupled to an external circuit module to obtain a working voltage to drive the LED chips to emit light. Therefore, the integrally formed light emitting ribbon can be sewed, hot-glued, or installed onto clothing through a connecting portion, so that the clothing has a light emitting function.

### BACKGROUND OF THE INVENTION

1. Field of the Invention The present invention relates to the technical field of clothing accessories, in particular to a light emitting ribbon integrally formed and installed with LED chips, so that the clothing has a light emitting function

2. Description of the Related Art Since ancient times, people know how to use light to transmit messages for alerting disasters, asking for helps and giving warnings; and as technology advances, people further know how to use various types of optical components such as LED to produce a light source in addition to fire. In order to avoid accidents occurred to pedestrians or bicyclists at night or cloudy days due to a lack of light, flashlights and light reflectors can be installed on a bicycle, in addition to wearing bright-color clothing, such as clothes, pants, shoes and socks, gloves, hats and hair clips and other clothing accessories to enhance the degree of recognition, but this method also increases the total weight and weight of the bicycle and reduces the practicality of the bicycle. Furthermore, the bright-color clothing or the light reflectors installed at the rear side of the bicycle can give a limited warning effect, but cannot improve the safety efficiently. Therefore, increasingly more clothing with a light emitting effect including optical components such as LED chips, light emitting strips or optical fibers sewed, stuck or woven onto the clothing or decorative items are worn on a human body to enhance the warning effect.

With reference to FIG. 1 for an exploded view of a conventional LED lamp strip, the LED lamp strip 1 comprises two flexible bodies 10 wrapped around a light emitting strip 11, two magnetic elements 12 and a power supply element 13, wherein the light emitting strip 11 is manufactured by serially connecting positive and negative voltage lines 110 to a plurality of LEDs 111, and an end of the light emitting strip 11 is coupled to the power supply element 13, and one of the flexible bodies 10 includes a plurality of light transmitting openings 100 formed at positions corresponding to the LEDs 111 respectively. The magnetic elements 12 are disposed on both sides of the LED lamp strip 1 for attached and worn on a user's body. However, the light emitting strip 11 is coupled to the power supply element 13 directly, so that the strength at the connecting position is weak, thus causing an open circuit easily, and the magnetic elements 12 applicable for being attached onto a user's hand or leg is difficult to be installed on the clothing, and a low comfortability of wearing will limit the practicality and utility of the product.

### SUMMARY OF THE INVENTION

In view of the problems of the prior art, it is a primary objective of the present invention to provide a light emitting ribbon having a plurality of LED chips, and the ribbon is directly attached onto a clothing worn on a user's body to provide a light emitting function and enhance a warning effect, or make use of a change of the light emission from the LED chips and a color display effect to improve the design of the clothing.

To achieve the foregoing objective, the present invention provides a light emitting ribbon applicable to be installed on a clothing to provide a light emitting function to the clothing, comprising: a main body, which is a flexible first transparent strip-shaped ribbon and includes a plurality of first conductive wires and a plurality of LED chips installed therein, and the LED chips are separated from each other with an interval apart and connected in parallel with the first conductive wires; and an adapter, coupled to the main body and electrically coupled to an external circuit module to obtain a working voltage to drive the LED chips to emit light. The light emitting ribbon is integrally formed and can be installed on the clothing conveniently.

Wherein, the adapter is a mini universal serial bus (Mini USB) or micro universal serial bus (Micro USB) adapter. The LED chips are red light chips, blue light chips, white light chips, yellow light chips, green light chips or at least two of the abovementioned chips, and the circuit module includes a battery. If the LED chips include two different types of chips, one of the types of chips is driven by a high voltage level of the battery to emit light, and the other type of chips is driven by a low voltage level of the battery to emit light, so as to form a warning signal for low power level, or the circuit module includes a controller for driving the LEDs to emit light synchronously or divisionally. Therefore, the light emitting ribbon can notice users about the low power level by means of a dual color display function, or a multi-section display function is used to provide a variable lighting, so as to enhance the warning effect and safety.

In addition, the circuit module is usually installed in a pocket of the clothing, so that a portion of the main body is covered by the clothing, which does not require the light emitting function. With the consideration of the cost, the light emitting ribbon further comprises a threading member with an end coupled to the main body and the other end coupled to the adapter, and the threading member is a flexible second strip-shaped ribbon formed by alternately weaving a plurality of woven threads with a plurality of second conductive wires, and the second conductive wires are respectively and electrically coupled to the corresponding first conductive wires to extend the distance between the main body and the adapter. Therefore, the light emitting ribbon can be installed in the clothing through the threading member to reduce the length of the main body and the consumption of the LED chips, so as to lower the cost. To improve the strength of connecting the threading member with the main body, the main body further includes a fixing portion disposed at the connecting position of the threading member, and carried by a transparent thin film made of polyethylene (PE) and fixed to a plurality of contacts between the first conductive wires and the second conductive wires, and manufactured by wrapping a polyvinyl siloxane (PVS) material around the contacts and the transparent thin film.

Besides sewing the light emitting ribbon onto the clothing, the main body can further have a connecting portion which is a zipper, a Velcro, a button or a magnet sticker movably connected to the clothing or removed from the clothing to simplify the installation of the light emitting ribbon. In addition, the light emitting ribbon can be removed conveniently, so that the clothing can be washed easily.

The technical content of the present invention will become apparent with the detailed description of preferred embodiments and the illustration of related drawings as follows.

### BRIEF DESCRIPTION OF THE DRAWINGS

FIG. 1 is an exploded view of a conventional LED lamp strip;

FIG. 2 is a perspective view of a preferred embodiment of the present invention;

FIG. 3 is another perspective view of a preferred embodiment of the present invention;

FIG. 4 is a schematic view of an internal structure of another preferred embodiment of the present invention;

FIG. 5 is a schematic view of an application of another preferred embodiment of the present invention;

FIG. 6 is a schematic view of another application of another preferred embodiment of the present invention; and

FIG. 7 is a schematic view of another application of another preferred embodiment of the present invention.

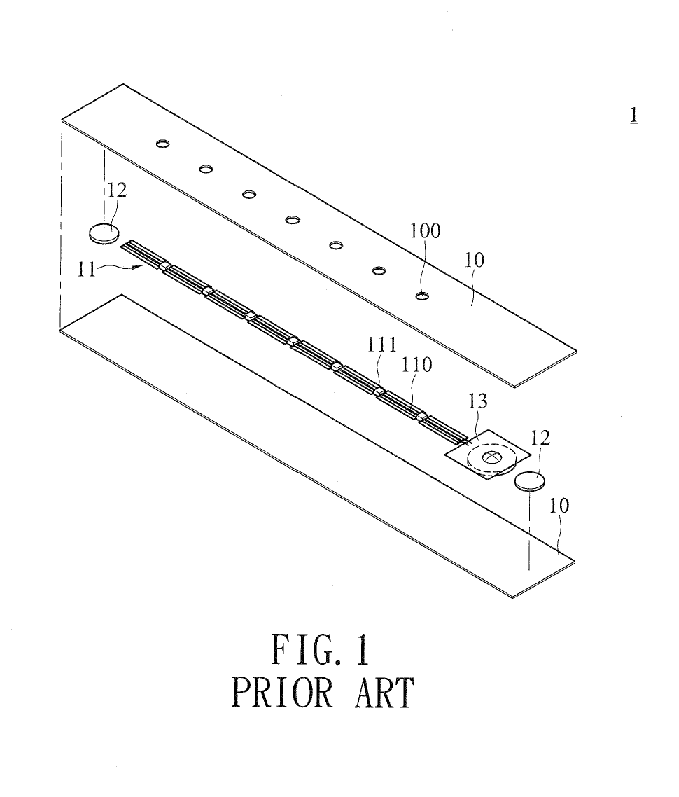

### DETAILED DESCRIPTION OF THE PREFERRED EMBODIMENTS

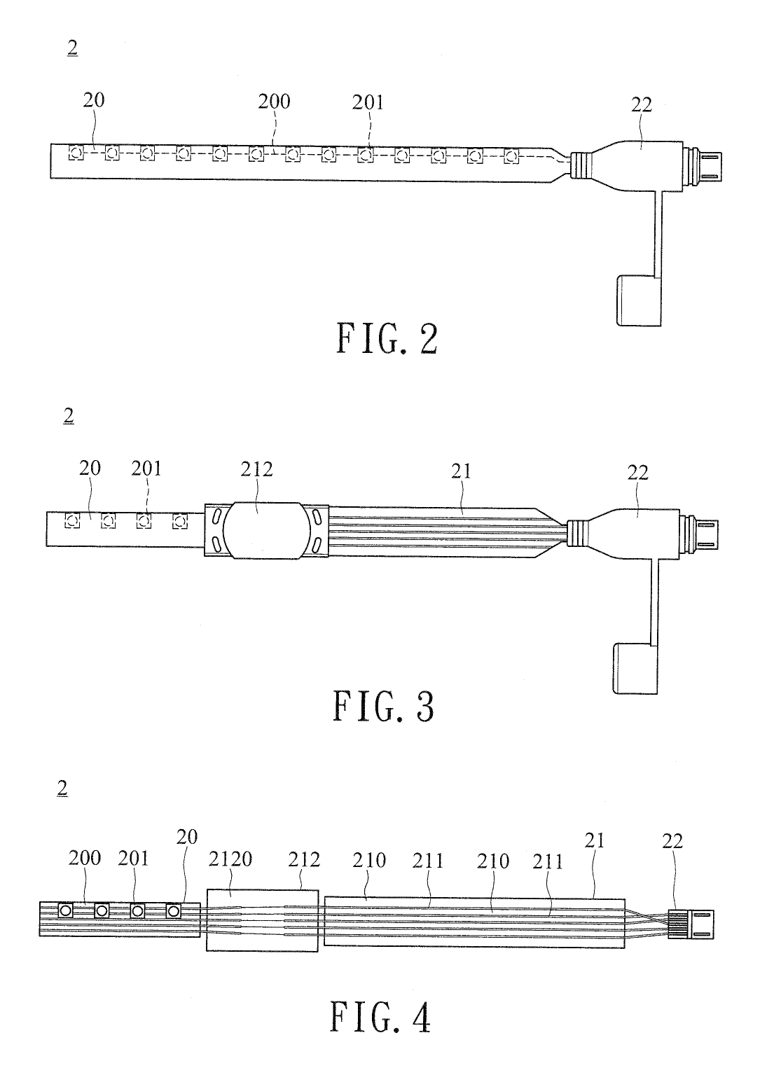

With reference to FIG. 2 for a perspective view of a preferred embodiment of the present invention, a light emitting ribbon 2 comprises a main body 20 and an adapter 22. The main body 20 is a first flexible transparent strip-shaped ribbon made by weaving woven threads and contains a plurality of first conductive wires 200 and a plurality of LED chips 201 such as red light chips, blue light chips, white light chips, yellow light chips or green light chips, and the LED chips 201 are separated from each other with an interval apart and connected in parallel with positive and negative electrode lines in the first conductive wires 200. After an end of the main body 20 is coupled to the threading member 21, the adapter 22 such as a mini universal serial bus (Mini USB) adapter or a micro universal serial bus (Micro USB) adapter is electrically coupled to an external circuit module 3 to obtain a working voltage to drive the LED chips 201 to emit light.

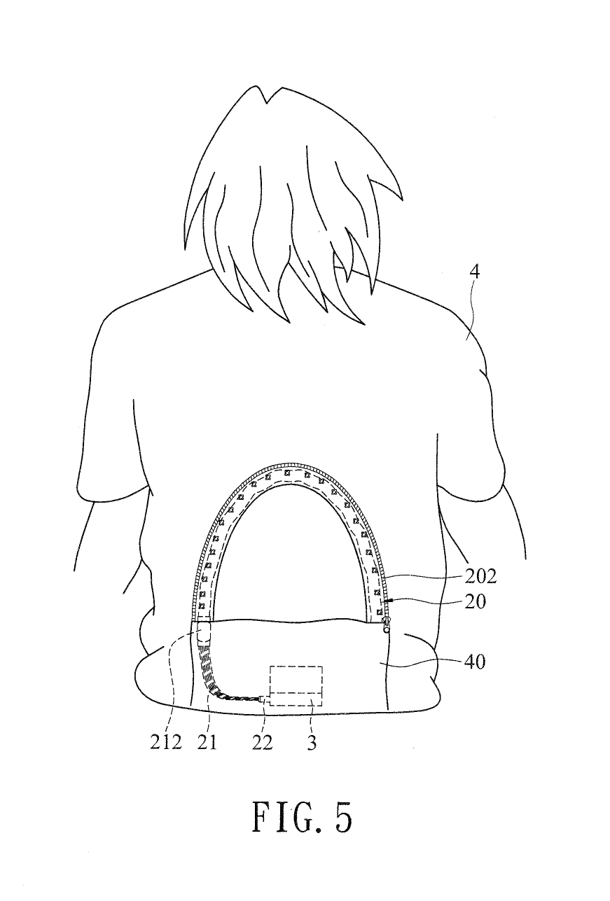

With reference to FIGS. 3 to 5 for a perspective view of a preferred embodiment of the present invention and schematic views of an internal structure and an application of a preferred embodiment of the present invention respectively, the light emitting ribbon 2 is integrally formed to facilitate its installation on a clothing 4 such as a bicycle shirt or jacket, so that the clothing 4 has a light emitting function. To reduce the consumption of the LED chips 201 and lower cost, the main body 20 can be extended by a threading member 21 and coupled to the adapter 22. The threading member 21 is a second strip-shaped ribbon formed by alternately weaving a plurality of woven threads 210 with a plurality of second conductive wires 211, and both ends of the second conductive wires 211 are respectively and electrically coupled to the corresponding first conductive wires 200 and a plurality of signal pins of the adapter 22, and a plurality of contacts between the second conductive wires 211 and between the first conductive wires 200 can be carried and fixed by a transparent thin film 2120 made of polyethylene (PE), and wrapped by a polyvinyl siloxane (PVS) material to form a fixing portion 212. Similarly, the second conductive wires 211 and the signal pins can be connected and fixed by the aforementioned method, so that the strength of connecting the threading member 21 with the main body 20 and the adapter 22 can be enhance to prevent the light emitting ribbon 2 from being damaged to cause an open circuit.

In this preferred embodiment, the circuit module 3 is a chargeable battery, and the LED chips 201 include two different types of chips such as white light chips and red light chips are installed alternately with one another. If the battery of the circuit module 3 is fully charged, then the white-light LED chips 201 will emit light, or else the red-light LED chips 201 will emit light, so as to form a warning signal for a low power level and notice users to charge the battery. In addition, the light emitting ribbon 2 can be sewed directly or hot glued onto the clothing 4 to facilitate washing the clothing 4, and the main body 20 can have a connecting portion 202 such as a zipper, a Velcro, a button or a magnet sticker movably coupled to the clothing 4 or removed from the clothing to simplify the installation, and the circuit module 3 can be installed in a pocket 40 of the clothing 4, and the threading member 21 is provided for the main body 20 with power, so that the threading member 21 can cover the length of the main body hidden in the clothing 4 to lower the cost.

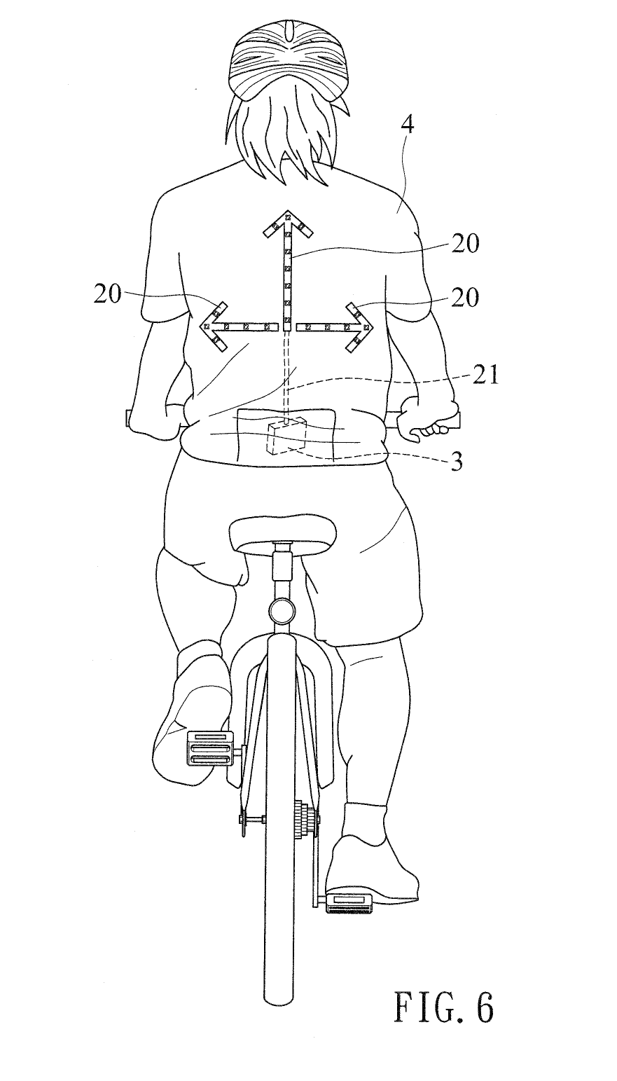

With reference to FIG. 6 for a schematic view of another application of a preferred embodiment of the present invention, several light emitting ribbons 2 can be sewed onto the clothing 4 to form forward, right-turn, and left-turn indicating patterns. The circuit module 3 is a controller controlled by a remote controller (not shown in the figure) through a cable or a wireless transmission to drive the LEDs 201 to emit light synchronously or divisionally. For example, if a bicycle rider wants to make a right turn, the bicycle rider can switch the remote control to drive the circuit module 3 to emit a light corresponding to the right-turn indicating pattern from the light emitting ribbon 2, so that the light emitting ribbons 2 can emit light corresponding to the riding direction according to the bicycle rider's instruction to warn cars coming from behind and enhance the rider's safety. If the LED chips 201 include two or more different types of chips, the circuit module 3 can be drive divisionally to form different sections of color display in order to increase the variation of the light and improve the warning effect.

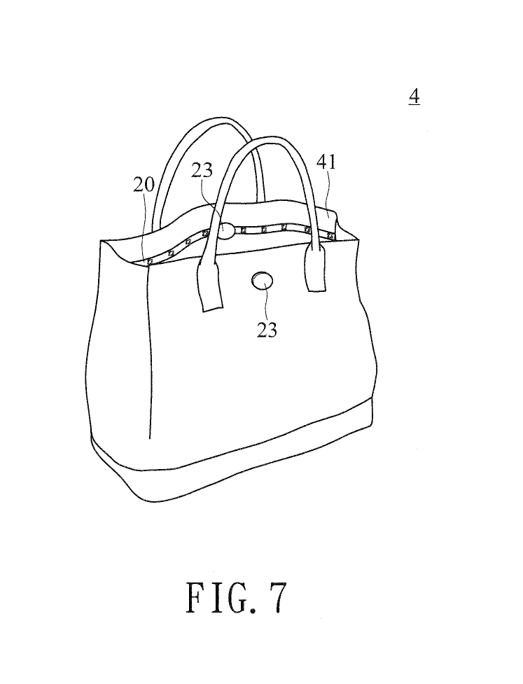

With reference to FIG. 7 for a schematic view of another application of a preferred embodiment of the present invention, the light emitting ribbons 2 are installed onto a handbag or a backpack, or on both sides of the clothing 4, and the light emitting ribbons 2 are separately connected in series with a sensor 23, and the sensors 23 can be installed in a pair of buttons, such that when the pair of buttons are separated (which means that the user opens the handbag) the light emitting optical fiber ribbons 2 will emit light to provide an illumination function and facilitate the user to search a desired object in the handbag.

What is claimed is:

1. A light emitting ribbon, applicable to be installed on a clothing to provide a light emitting function to the clothing, comprising:
a main body, being a flexible first transparent strip-shaped ribbon, and including a plurality of first conductive wires and a plurality of LED chips installed therein, and the LED chips being separated from each other with an interval apart and connected in parallel with the first conductive wires; and
an adapter, coupled to the main body and electrically coupled to an external circuit module to obtain a working voltage to drive the LED chips to emit light.

2. The light emitting ribbon of claim 1, wherein the adapter is a mini universal serial bus (Mini USB) or micro universal serial bus (Micro USB) adapter.

3. The light emitting ribbon of claim 1, wherein the LED chips are red light chips, blue light chips, white light chips, yellow light chips, green light chips or at least two of the above.

4. The light emitting ribbon of claim 3, wherein the circuit module includes a battery, and when the LED chips include two different types of chips, one of the types of chips is driven by a high voltage level of the battery to emit light, and the other type of chips is driven by a low voltage level of the battery to emit light, so as to form a signal for warning a low power level.

5. The light emitting ribbon of claim 3, wherein the circuit module includes a controller that drives the LEDs to emit light synchronously or divisionally.

6. The light emitting ribbon of claim 1, further comprising a threading member with an end coupled to the main body and the other end coupled to the adapter, and the threading member is a flexible second strip-shaped ribbon formed by alternately weaving a plurality of woven threads and a plurality of second conductive wires, and the second conductive wires are respectively and electrically coupled to the corresponding first conductive wires to extend a distance between the main body and the adapter.

7. The light emitting ribbon of claim 6, wherein the main body further includes a fixing portion disposed at a connecting position of the threading member and carried by a transparent thin film made of polyethylene (PE) and fixed to a plurality of contacts between the first conductive wires and the second conductive wires, and manufactured by wrapping a polyvinyl siloxane (PVS) material around the contacts and the transparent thin film.

8. The light emitting ribbon of claim 1, wherein the main body further includes a connecting portion movably coupled to the clothing or removed from the clothing.

9. The light emitting ribbon of claim 8, wherein the connecting portion is one selected from the collection of a zipper, a Velcro, a button and a magnet sticker.
